(19) United States
(12) Patent Application Publication
(10) Pub. No.: US 2003/0093339 A1
(43) Pub. Date: May 15, 2003

(54) Method and system for integrating material quality data

(76) Inventors: Hung-Liang Chiu, Taipei (TW); Yih-Wen Tsai, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(21) Appl. No.: 10/004,341

(22) Filed: Nov. 14, 2001

(51) Int. Cl. G06F 17/60

(52) U.S. Cl. 705/28

(57) ABSTRACT

A method and a system for integrating material quality data are proposed, in which manufactories of a manufacturer at different locations can be connected through a network communication system to the integrating system, wherein the system has a supplier database for storing basic data of the material suppliers and an examination database for storing quality examined data established by the manufactories, and each of the material suppliers has a supplier code corresponding to the basic data thereof. In the use of the foregoing method and system, a common inputting interface used for material quality examination can be provided for IQC departments of the manufactories of the manufacturer, and quality examined data of the manufactories can be integrated, so as to allow the manufactories to immediately monitor qualities of incoming materials from material suppliers, thereby making manufactured products greatly improved in quality for the manufacturer.

### FIELD OF THE INVENTION

The present invention relates to methods and systems for integrating material quality data, and more particularly, to a method and a system for integrating material quality data, in which a manufacturer can integrate and monitor incoming material quality data from its manufactories, allowing a warning to be generated if certain materials provided from a material supplier are unqualified, so that qualities of manufactured products can be assured.

### BACKGROUND OF INVENTION

In response to demand for instant product availability in the market, an enterprise normally establishes multiple trading branches at different locations, wherein, in exemplification of a manufacturer, besides domestic manufactories, overseas manufactories are also built up, so as to save costs in material transportation and shorten time for product delivery.

However, currently due to lack of a system for integrating material quality data provided by the manufacturer for its manufactories, an IQC (incoming quality control) department of the manufactory can only manually examine qualities of incoming materials. This makes it difficult and complex to obtain a report of quality examined results, and generally the manufactories are not capable of interchanging or communicating with one another for the quality examining reports. As a result, qualities of materials provided by material suppliers cannot be effectively monitored, thereby easily causing errors in material replenishment or problems of quality dissatisfaction. In addition, further due to lack of communication in material data, the manufactories are thus not able to make good use of material resources by sharing the materials with each other if necessary, but nevertheless make product manufacture undesirably increased in cost due to incomplete information of material quality data, which even possibly delays product manufacture and exportation.

Therefore, it is definitely desired to develop a method and a system for integrating material quality data, so as to effectively integrate quality data of incoming materials provided from material suppliers, and provide the integrated data for manufactories of a manufacturer to be immediately monitored, so that material resources can be well utilized, and qualities of manufactured products can be assured.

### SUMMARY OF THE INVENTION

A primary objective of the present invention is to provide a method and a system for integrating material quality data, in which a manufacturer can integrate examined data of material qualities established by IQC departments of its manufactories, so as to allow the manufactories to communicate with each other for quality conditions of incoming materials through a network, in an effort to share and make good use of material resources.

Another objective of the invention is to provide a method and a system for integrating material quality data, in which a warning is immediately generated to the manufactories if qualities of incoming materials from material suppliers are unsatisfactory, so as to effectively avoid the occurrence of inferior products.

In accordance with the foregoing and other objectives, the present invention proposes a method and a system for integrating material quality data. The method for integrating material quality data is used to connect manufactories of a manufacturer to a system for integrating material quality data through a network communication system such as internet or intranet, so as to allow the manufactories to immediately monitor qualities of incoming materials provided by material suppliers, wherein the integrating system has a supplier database for storing basic data of the material suppliers and an examination database for storing quality examined data established by the manufactories, and each of the material suppliers has a supplier code corresponding to the basic data thereof.

The method for integrating material quality data of the invention comprises the steps of: (1) submitting a request for establishing quality examined data of an incoming material via a user at a terminal device of a manufactory through a browser of the terminal device and the network communication system to the integrating system; transmitting a data input table to the browser of the terminal device via the integrating system, so as to allow the user to input the quality examined data; and storing the quality examined data inputted by the user via the integrating system into the examination database, wherein the quality examined data includes a material category number, a material name of the incoming material, a supplier code of a material supplier who provides the incoming material, a total quantity of the material, a sampling quantity of the material for examination, a quantity of inferior material, a report of material inferiority, and a quantity of the material passing the examination; (2) submitting a request for inquiring material incoming conditions of material suppliers via the manufactory to the integrating system; searching via the integrating system in the examination database for quality examined data corresponding to supplier codes of the material suppliers, and integrating the searched quality examined data of the same supplier code, so as to calculate a number of incoming material categories, a number of times of material inferiority in quality examination and a quantity of incoming materials for each of the material suppliers; and displaying the calculated data via the integrating system in a form of a quality display table on the browser of the terminal device, so as to allow the user at the terminal device to obtain the material incoming conditions of the material suppliers, wherein the quality display table of the material supplier includes quality data of incoming materials provided by the material supplier, and the quality data include the number of the incoming material categories, the number of times of material inferiority in quality examination, a report of material inferiority, a sampling quantity of the incoming materials for quality examination and the quantity of the incoming materials, whereas the supplier code of the material supplier is used as an identification number of the quality data; and (3) submitting a request for inquiring a quality condition of an incoming material provided by a certain material supplier via the manufactory to the integrating system; retrieving quality examined data from the examination database via the integrating system corresponding to a supplier code and a material name inputted by the user at the terminal device; and displaying the retrieved quality examined data via the integrating system in a form of a condition display table on the browser of the terminal device, so as to allow the user to obtain the material quality condition of the quality examined data.

Moreover, prior to performing the step (2), the integrating system searches the examination database if there are newly-established quality examined data relating to an incoming material inferior in quality; and if such quality examined data are available, the integrating system forms a condition display table by the searched quality examined data of material inferiority, and displays the condition display table through the network communication system to the browser of the terminal device of the manufactory, so as to immediately inform the manufactory of a warning message of material inferiority.

Furthermore, the material incoming condition of the material supplier in the step (2) is determined for a period of time, so as to allow the manufactory to realize a material supplying condition of the material supplier for determining a material number for examination. The material quality condition of the quality examined data in the step (3) is determined for a period of time, so as to allow the manufactory to realize a material supplying condition of the material supplier for determining a material number for examination.

The system for integrating material quality data of the invention is connected to manufactories of a manufacturer through a network communication system, so as to allow the manufactories to immediately monitor qualities of incoming materials provided by material suppliers, wherein the integrating system has a supplier database for storing basic data of the material suppliers, and each of the material suppliers has a supplier code corresponding to the basic data thereof. The integrating system comprises: an examination database for storing quality examined data established by an manufactory; an analyzing module for receiving an input request submitted by a user at a terminal device of the manufactory, and for generating a corresponding signal according to the input request; a tabling module having a plurality of tables, for transmitting a corresponding table according to the corresponding signal generated by the analyzing module, and for displaying the corresponding table to a browser of the terminal device for display, so as to allow the user to input data or obtain desired data according to the displayed table, wherein the tabling module stores at least a data input table, a quality display table and a condition display table; and a retrieving module for retrieving the inputted data of the user at the terminal device from the displayed table, wherein if the user submits a request for establishing quality examined data of an incoming material to the analyzing module, the tabling module is prompted by the analyzing module to transmit the data input table to the browser of the terminal device for allowing the user to input the quality examined data relating to a category number of the material, a name of the material, a supplier code of a material supplier who provides the material, a quantity of the material, a sampling quantity of the material for quality examination, a quantity of the material inferior in quality, a report of material inferiority and a quantity of the material passing the examination; if the quality examined data are inputted by the user and transmitted to the analyzing module, the retrieving module is prompted to receive the quality examined data from the analyzing module, and take the supplier code of the material supplier in the quality examined data as an identification number, allowing the quality examined data to be stored in the examination database; if the user at the terminal device of the manufactory submits a request for inquiring material incoming conditions of material suppliers to the analyzing module, the retrieving module is prompted by the analyzing module to search in the examination database for quality examined data corresponding to supplier codes of the material suppliers, and the analyzing module integrates the searched quality examined data of the same supplier code, so as to calculate a number of incoming material categories, a number of times of material inferiority in quality examination a sampling quantity of incoming materials for quality examination and a quantity of the incoming materials for each of the material suppliers; and the tabling module is prompted by the analyzing module to display the calculated data in a form of the quality display table on the browser of the terminal device, whereas the quality display table includes quality data of the incoming materials provided by the material supplier, and the quality data include the number of the incoming material categories, the number of times of material inferiority in quality examination, a report of material inferiority, the sampling quantity of the incoming materials for quality examination and the quantity of the incoming materials, allowing the supplier code of the material supplier to be used as an identification number of the quality data; and if the user at the terminal device submits a request for inquiring a quality condition of an incoming material to the analyzing module, the retrieving module is prompted by the analyzing module to retrieve quality examined data from the examination database corresponding to a material name of the incoming material, and the tabling module is prompted by the analyzing module to display the retrieved quality examined data in a form of the condition display table on the browser of the terminal device.

In the use of the method and system for integrating material quality data of the invention, manufactories of a manufacturer at different locations can be connected through a network communication system to the integrating system, so as to immediately monitor quality conditions of incoming materials from material suppliers, and to avoid the occurrence of inferiority in manufactured products, in an effort to optimize the use of material resources and yield of the manufactured products.

### BRIEF DESCRIPTION OF THE DRAWINGS

The present invention can be more fully understood by reading the following detailed description of the preferred embodiments, with reference made to the accompanying drawings wherein:

FIG. 1 is a schematic block diagram showing basic architecture of a preferred embodiment of a system for integrating material quality data of the invention;

FIG. 2 is a schematic diagram depicting a preferred embodiment of a method for integrating material quality data of the invention; and

FIGS. 3(A)-3(C) are schematic diagrams showing pictures displayed on a browser of a terminal device in the use of a method for integrating material quality data of the invention.

### DETAILED DESCRIPTION OF THE PREFERRED EMBODIMENT

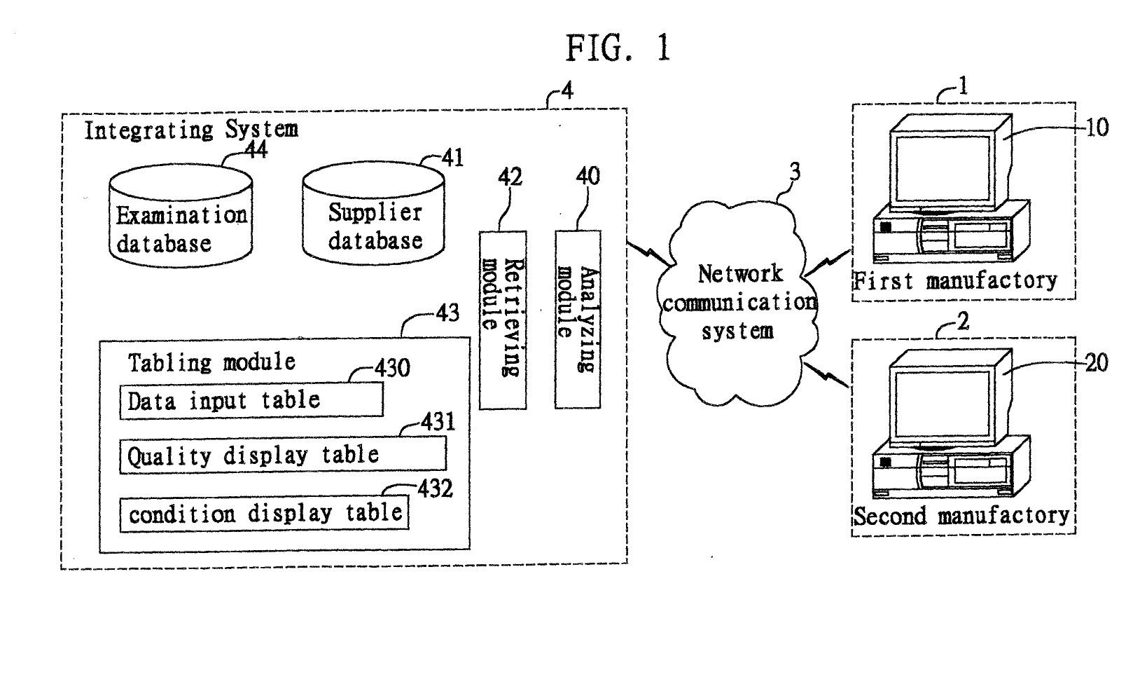

Referring to FIG. 1, it illustrates basic architecture of a system for integrating material quality data 4 of the invention. As shown in the drawing, a network communication system 3 such as internet or intranet is used to connect a first manufactory 1 and a second manufactory 2 to the system for integrating material quality data 4 of the invention. Such an integrating system 4 allows the first manufactory 1 and the second manufactory 2 to share and communicate examined data of material qualities with each other, so as to effectively monitor qualities of incoming materials provided by material suppliers in real time. After terminal devices 10, 20 of the first manufactory 1 and the second manufactory 2 are respectively connected to the integrating system 4 through a network (the terminal devices and manufactories are not limited in number as shown in the drawing, but can be provided in greater or variable quantity), the integrating system 4 in advance generates an identification request to a user at the terminal device 10, 20; that is, the use is asked to input a user's account and a password for identification. After the user is successfully identified by the integrating system 4, the user is allowed to login and operate the integrating system 4. Since such an identification process for loginning a network is generally conventional, it is not further described herein. The integrating system 4 comprises an analyzing module 40, a supplier database 41, a retrieving module 42, a tabling module 43 and an examination database 44.

Prior to the integrating system 4 integrating examined data of material qualities, first, the first manufactory 1 and the second manufactory 2 need to establish basic data of each material suppler who provides materials for the manufactories 1, 2. The basic suppler data include a name of the material suppler, a location of the material suppler, material items provided by the material suppler, etc. A supplier code is assigned corresponding to the name of each material suppler, and the basic suppler data are stored in the supplier database 41. Therefore, after a name or a suppler code of a material suppler is inputted to the integrating system 4, a user at a terminal device of a manufactory is allowed to retrieve basic data of the material suppler via a browser of the terminal device.

The analyzing module 40 of the integrating system 4 is used to receive a request submitted from the terminal device 10, 20, and correspondingly generates a treatment procedure according to the received request. The treatment procedure includes establishment of the foregoing basic data of material suppliers stored in the supplier database 41. Since such data establishment of inputting the material supplier data and constructing the supplier database 41 employs conventional technology, it is not further described in detail, but only associated part relating to integration of material quality data and retrieval of the integrated data is depicted herein. Moreover, the treatment procedure also includes generation of a corresponding table by the tabling module 43 to a browser of the terminal device 10, 20 for display according to the received request of the analyzing module 40, so as to allow a user to input data to the displayed table. The tabling module 43 comprises a data input table 430, a quality display table 431 and a condition display table 432. After an IQC (incoming quality control) department of the first manufactory 1 or the second manufactory 2 receives incoming materials and examine qualities of the incoming materials, the IQC department at the terminal device 10, 20 can submit a request for establishing examined data of the material qualities to the analyzing module 40. The tabling module 43 is then prompted by the analyzing module 40 to display a data input table 430 stored therein on the browser of the terminal device 10, 20, so as to allow the IQC department to input the examined data of the material qualities to the displayed data input table 430. Such quality examined data include: a category code of the incoming material, a name of the material, a supplier code, a total quantity of the material, a sampling quantity of the material for quality examination, an inferior quantity of the examined material, a report of material inferiority in examination, a quantity of the material passing the examination, etc. After the quality examined data inputted by the IQC department to the data input table 430 are transmitted back to the analyzing module 40, the retrieving module 42 is prompted to receive the quality examined data received by the analyzing module 40, and accordingly assign an identification number corresponding to a supplier code and a material name in the quality examined data, which is to be stored in the examination database 44.

If the IQC department of the terminal device 10, 20 submits a request for inquiring conditions of incoming materials from material suppliers to the analyzing module 40, the retrieving module 42 is prompted by the analyzing module 40 to search in the examination database 44 for quality examined data corresponding to suppler codes of the material suppliers. Then, the analyzing module 40 classifies the quality examined data according to the suppler codes, and integrates the quality examined data of the same supplier code, so as to calculate a total number of categories of incoming materials, a count of inferiority in quality examination of the incoming materials, a total quantity of the incoming materials, and a sampling material quantity for quality examination for each material supplier. Subsequently, the tabling module 43 is prompted by the analyzing module 40 to form a quality display table 431 of the material supplier according to the calculated data, and display the quality display table 431 on the browser of the terminal device 10, 20. The quality display table 431 indicates quality conditions of incoming materials of the material supplier, and the material quality conditions include a total number of categories of the incoming materials, a count of inferiority in quality examination of the incoming materials, a report of inferior materials after quality examination, a total quantity of the incoming materials, and a sampling material quantity for quality examination, wherein a supplier code of the material supplier is used as an identification number.

Therefore, in the use of the integrating system 4 of the invention, for the first manufactory 1 and the second manufactory 2 of a manufacturer in different locations for product manufacture, a material purchasing department, IQC department or associated department thereof can immediately realize quality conditions of incoming materials provided by material suppliers through the browser of the terminal device 10, 20 at the respective manufactory 1, 2, according to data illustrated in quality display tables 431 of the material suppliers. This is also to inform all manufactories of the manufacturer about certain material suppliers that provide unsatisfactory materials, for the purpose of sharing material quality data and warnings of inferior incoming materials between the manufactories at the same time.

Moreover, the user at the terminal device 10, 20 can submit a request for inquiring conditions of incoming materials to the analyzing module 40 of the integrating system 4. First, the retrieving module 42 is prompted by the analyzing module 40 to retrieve quality examined data corresponding to a material name inputted by the user from the examination database 44. Then, the tabling module 43 is prompted by the analyzing module 40 to form a condition display table 432 according to the retrieved quality examined data, wherein the condition display table 432 is displayed on the browser of the terminal device 10, 20.

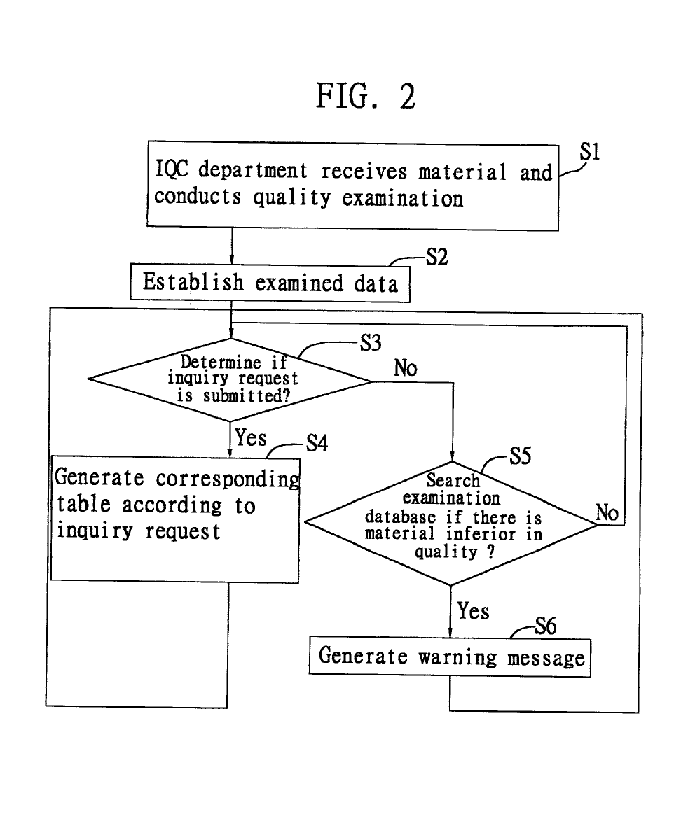

Referring to FIG. 2, it illustrates a preferred embodiment of a method for integrating material quality data of the invention. The following description is made with reference to FIGS. 1 and 2 for depicting the method for integrating material quality data of the invention.

First, in step S1, when an IQC department of a manufactory 1, 2 receives incoming materials, the IQC department examines qualities of the incoming materials, and then step S2 is followed.

In step S2, after material quality examination is completed, the IQC department is connected through its terminal device 10, 20 to the foregoing integrating system 4 of the invention, and submits a request for establishing examined data of material qualities to the integrating system 4. An analyzing module 40 of the integrating system 4 prompts an tabling module 43 to transmit a data input table 430 to a browser of the terminal device 10, 20 for display, allowing the IQC department to input data relating to quality examined results to the data input table 430. Then, a retrieving module 42 is prompted by the analyzing module 40 to retrieve the inputted data of the IQC department in the data input table 430, so as to establish quality examined data to be stored in an examination database 44. Thereafter, step S3 is followed.

In step S3, the analyzing module 40 determines if the terminal device 10, 20 submits a request for inquiring quality examined data. If the inquiry request is received by the analyzing module 40, then step S4 is followed; or else, step S5 is followed.

In step S4, according to the received inquiry request from the terminal device 10, 20, the analyzing module 40 prompts the retrieving module 42 to retrieve corresponding quality examined data from the examination database 44, and also prompts the tabling module 43 to form a display table to be displayed on the browser of the terminal device 10, 20 according to the retrieved quality examined data. For example, if a user at the terminal device 10, 20 submits a request for inquiring material incoming conditions of material suppliers, then a quality display table 431 is displayed; if the user submits a request for inquiring a condition of a certain incoming material, then a condition display table 432 is illustrated. Thereafter, the step S3 is returned thereto.

In step S5, the analyzing module 40 prompts the retrieving module 42 to search the examination database 44 if there are newly-established quality examined data relating to material inferiority. If such quality examined data are available, then step S6 is followed; or else, the step S3 is returned thereto.

In step S6, according to the searched quality examined data of material inferiority from the retrieving module 42, the analyzing module 40 prompts the tabling module 43 to form a condition display table 432 to be displayed on the browser of the terminal device 10, 20 through a network communication system 3. This therefore allows a warning message of material quality inferiority to be immediately available for the manufactory 1, 2. In other words, after a manufactory examines qualities of incoming materials and finds out some of the materials unsatisfactory in quality, an associated message of the unsatisfactory materials can be transmitted to other manufactories in real time, so as to reduce inferiority in manufactured products of the manufactories.

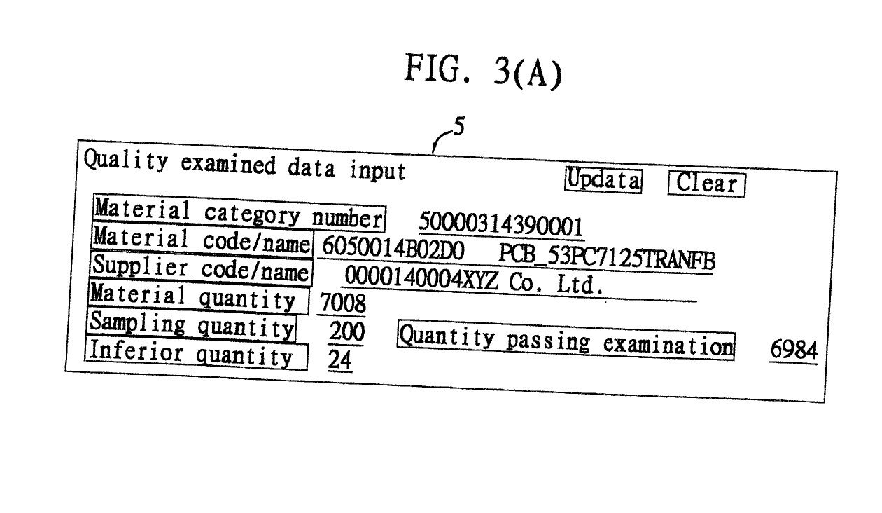

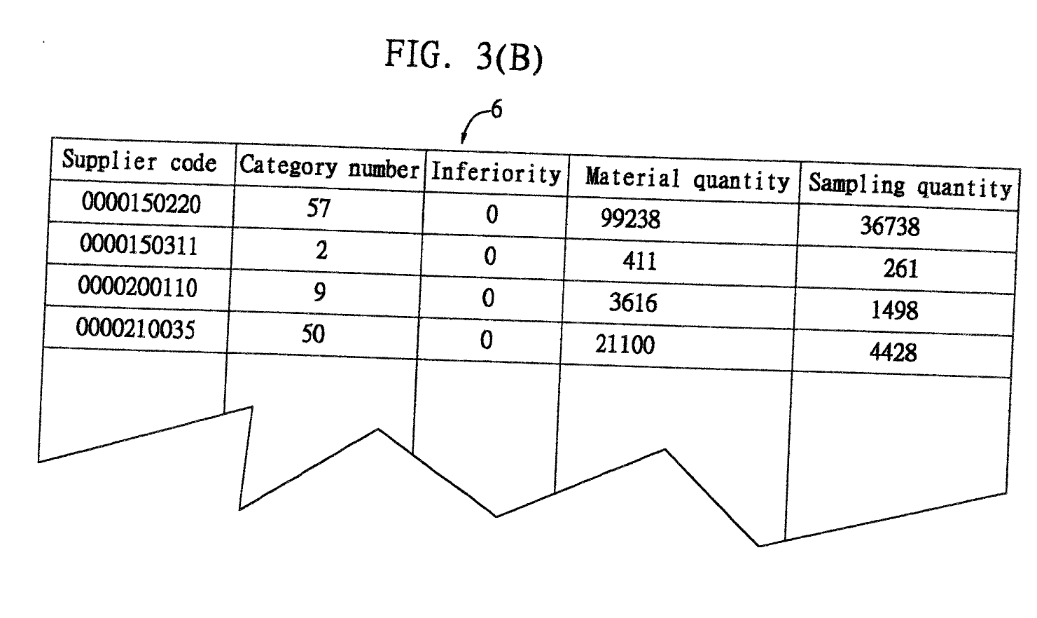

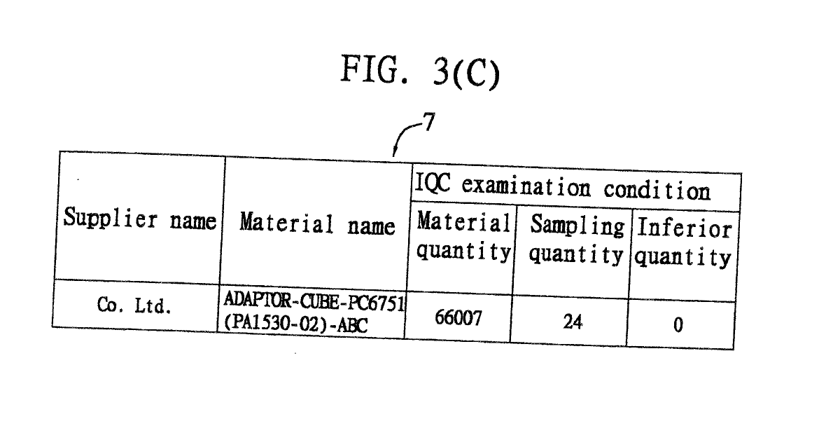

Referring to FIGS. 3(A)-3(C), they illustrate pictures displayed on a browser of a terminal device in the use of a method for integrating material quality data of the invention. As shown in FIG. 3(A), a picture 5 for inputting examined data of incoming materials is displayed on the browser of the terminal device as proceeding step S2 of FIG. 2. An IQC department examines qualities of incoming materials in a sampling manner, and inputs data relating to quality examined results to the picture 5. Then, an analyzing module 40 prompts a retrieving module 42 to retrieve the inputted data from the picture 5, and to form quality examined data, which are to be stored in an examination database 44.

Moreover, referring to FIGS. 3(B) and 3(C), pictures 6, 7 are respectively displayed on the browser of the terminal device according to different inquiry requests from a user as proceeding step S4 of FIG. 2. As shown in FIG. 3(B), if the user at terminal device 10, 20 submits a request for inquiring material incoming conditions of material suppliers to the analyzing module 40, the retrieving module 42 is prompted by the analyzing module 40 to search in the examination database 44 for corresponding quality examined data according to supplier codes of the material suppliers. Then, the analyzing module 40 classifies the searched quality examined data according to the supplier codes, and integrates the quality examined data of the same supplier code, so as to calculate data relating to a number of material categories, a quantity of inferior materials, a total quantity of incoming materials and a sampling material quantity for each of the material suppliers. Finally, the calculated data are displayed in the form of the picture 6 (i.e. the foregoing quality display table 431) on the browser of the terminal device. As shown in FIG. 3(C), if the user submits a request for inquiring a condition of a certain incoming material to the analyzing module 40, the retrieving module 42 is prompted by the analyzing module 40 to retrieve in the examination database 44 for corresponding quality examined data according to a name of the material. Then, the analyzing module 40 prompts a tabling module 43 to display the retrieved quality examined data in the form of the picture 7 (i.e. the foregoing condition display table 432) on the browser of the terminal device.

Therefore, in the use of the method and system for integrating material quality data of the invention, a common inputting interface used for material quality examination can be provided for IQC departments of various manufactories of a manufacturer, and quality examined data of the manufactories can be integrated, so as to allow the manufactories to immediately monitor qualities of incoming materials from material suppliers, thereby making manufactured products greatly improved in quality for the manufacturer.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for integrating material quality data, used to connect manufactories of a manufacturer through a network communication system to a system for integrating material quality data, so as to allow the manufactories to immediately monitor qualities of incoming materials provided by material suppliers, wherein the integrating system has a supplier database for storing basic data of the material suppliers and an examination database for storing quality examined data established by the manufactories, and each of the material suppliers has a supplier code corresponding to the basic data thereof; the method comprising the steps of:
(1) submitting a request for establishing quality examined data of an incoming material via a user at a terminal device of a manufactory through a browser of the terminal device and the network communication system to the integrating system; transmitting a data input table to the browser of the terminal device via the integrating system, so as to allow the user to input the quality examined data; and storing the quality examined data inputted by the user via the integrating system into the examination database, wherein the quality examined data includes a supplier code of a material supplier who provides the incoming material, and a material name of the incoming material;
(2) submitting a request for inquiring material incoming conditions of material suppliers via the manufactory to the integrating system; searching via the integrating system in the examination database for quality examined data corresponding to supplier codes of the material suppliers, and integrating the searched quality examined data of the same supplier code, so as to calculate a number of incoming material categories, a number of times of material inferiority in quality examination and a quantity of incoming materials for each of the material suppliers; and displaying the calculated data via the integrating system in a form of a quality display table on the browser of the terminal device, so as to allow the user at the terminal device to obtain the material incoming conditions of the material suppliers; and
(3) submitting a request for inquiring a quality condition of an incoming material provided by a certain material supplier via the manufactory to the integrating system; retrieving quality examined data from the examination database via the integrating system corresponding to a supplier code and a material name inputted by the user at the terminal device; and displaying the retrieved quality examined data via the integrating system in a form of a condition display table on the browser of the terminal device, so as to allow the user to obtain the material quality condition of the quality examined data.

2. The method of claim 1, wherein in the step (1), the quality examined data of the incoming material include: a material category number, the material name, the supplier code, a total quantity of the material, a sampling quantity of the material for examination, a quantity of inferior material, a report of material inferiority, and a quantity of the material passing the examination.

3. The method of claim 1, wherein prior to performing the step (2), the integrating system searches the examination database if there are newly-established quality examined data relating to an incoming material inferior in quality; and if such quality examined data are available, the integrating system forms a condition display table by the searched quality examined data of material inferiority, and displays the condition display table through the network communication system to the browser of the terminal device of the manufactory, so as to immediately inform the manufactory of a warning message of material inferiority.

4. The method of claim 1, wherein in the step (2), the quality display table of the material supplier includes quality data of incoming materials provided by the material supplier, and the quality data include the number of the incoming material categories, the number of times of material inferiority in quality examination, a report of material inferiority, a sampling quantity of the incoming materials for quality examination and the quantity of the incoming materials, whereas the supplier code of the material supplier is used as an identification number of the quality data.

5. The method of claim 1, wherein in the step (2), the material incoming condition of the material supplier is determined for a period of time, so as to allow the manufactory to realize a material supplying condition of the material supplier for determining a material number for examination.

6. The method of claim 1, wherein in the step (3), the material quality condition of the quality examined data is determined for a period of time, so as to allow the manufactory to realize a material supplying condition of the material supplier for determining a material number for examination.

7. The method of claim 1, wherein the network communication system is internet or intranet.

8. A system for integrating material quality data, connected to manufactories of a manufacturer through a network communication system, so as to allow the manufactories to immediately monitor qualities of incoming materials provided by material suppliers, wherein the integrating system has a supplier database for storing basic data of the material suppliers, and each of the material suppliers has a supplier code corresponding to the basic data thereof, the system comprising:
an examination database for storing quality examined data established by an manufactory;
an analyzing module for receiving an input request submitted by a user at a terminal device of the manufactory, and for generating a corresponding signal according to the input request;
a tabling module having a plurality of tables, for transmitting a corresponding table according to the corresponding signal generated by the analyzing module, and for displaying the corresponding table to a browser of the terminal device for display, so as to allow the user to input data or obtain desired data according to the displayed table; and
a retrieving module for retrieving the inputted data of the user at the terminal device from the displayed table, wherein if the user submits a request for establishing quality examined data of an incoming material to the analyzing module, the tabling module is prompted by the analyzing module to transmit a data input table to the browser of the terminal device for allowing the user to input the quality examined data; and if the quality examined data are inputted by the user and transmitted to the analyzing module, the retrieving module is prompted to receive the quality examined data from the analyzing module, and take a supplier code in the quality examined data as an identification number, allowing the quality examined data to be stored in the examination database.

9. The system of claim 8, wherein if the user at the terminal device of the manufactory submits a request for inquiring material incoming conditions of material suppliers to the analyzing module, the retrieving module is prompted by the analyzing module to search in the examination database for quality examined data corresponding to supplier codes of the material suppliers, and the analyzing module integrates the searched quality examined data of the same supplier code, so as to calculate a number of incoming material categories, a number of times of material inferiority in quality examination a sampling quantity of incoming materials for quality examination and a quantity of the incoming materials for each of the material suppliers; and the tabling module is prompted by the analyzing module to display the calculated data in a form of a quality display table on the browser of the terminal device, whereas the quality display table includes quality data of the incoming materials provided by the material supplier, and the quality data include the number of the incoming material categories, the number of times of material inferiority in quality examination, a report of material inferiority, the sampling quantity of the incoming materials for quality examination and the quantity of the incoming materials, allowing the supplier code of the material supplier to be used as an identification number of the quality data.

10. The system of claim 8, wherein if the user at the terminal device submits a request for inquiring a quality condition of an incoming material to the analyzing module, the retrieving module is prompted by the analyzing module to retrieve quality examined data from the examination database corresponding to a material name of the incoming material, and the tabling module is prompted by the analyzing module to display the retrieved quality examined data in a form of a condition display table on the browser of the terminal device.

11. The system of claim 8, wherein the retrieving module is prompted by the analyzing module to search the examination database if there are newly-established quality examined data relating to an incoming material inferior in quality; and if such quality examined data are available, the analyzing module forms a condition display table by the searched quality examined data of material inferiority, and displays the condition display table through the network communication system to the browser of the terminal device of the manufactory, so as to immediately inform the manufactory of a warning message of material inferiority.

12. The system of claim 8, wherein the network communication system is internet or intranet.

13. A system for integrating material quality data, connected to manufactories of a manufacturer through a network communication system, so as to allow the manufactories to immediately monitor qualities of incoming materials provided by material suppliers, wherein the integrating system has a supplier database for storing basic data of the material suppliers, and each of the material suppliers has a supplier code corresponding to the basic data thereof; the system comprising:
an examination database for storing quality examined data established by an manufactory;
an analyzing module for receiving an input request submitted by a user at a terminal device of the manufactory, and for generating a corresponding signal according to the input request;
a tabling module having a plurality of tables, for transmitting a corresponding table according to the corresponding signal generated by the analyzing module, and for displaying the corresponding table to a browser of the terminal device for display, so as to allow the user to input data or obtain desired data according to the displayed table, wherein the tabling module stores at least a data input table, a quality display table and a condition display table; and
a retrieving module for retrieving the inputted data of the user at the terminal device from the displayed table, wherein if the user submits a request for establishing quality examined data of an incoming material to the analyzing module, the tabling module is prompted by the analyzing module to transmit the data input table to the browser of the terminal device for allowing the user to input the quality examined data relating to a category number of the material, a name of the material, a supplier code of a material supplier who provides the material, a quantity of the material, a sampling quantity of the material for quality examination, a quantity of the material inferior in quality, a report of material inferiority and a quantity of the material passing the examination; if the quality examined data are inputted by the user and transmitted to the analyzing module, the retrieving module is prompted to receive the quality examined data from the analyzing module, and take the supplier code of the material supplier in the quality examined data as an identification number, allowing the quality examined data to be stored in the examination database; if the user at the terminal device of the manufactory submits a request for inquiring material incoming conditions of material suppliers to the analyzing module, the retrieving module is prompted by the analyzing module to search in the examination database for quality examined data corresponding to supplier codes of the material suppliers, and the analyzing module integrates the searched quality examined data of the same supplier code, so as to calculate a number of incoming material categories, a number of times of material inferiority in quality examination a sampling quantity of incoming materials for quality examination and a quantity of the incoming materials for each of the material suppliers; and the tabling module is prompted by the analyzing module to display the calculated data in a form of the quality display table on the browser of the terminal device, whereas the quality display table includes quality data of the incoming materials provided by the material supplier, and the quality data include the number of the incoming material categories, the number of times of material inferiority in quality examination, a report of material inferiority, the sampling quantity of the incoming materials for quality examination and the quantity of the incoming materials, allowing the supplier code of the material supplier to be used as an identification number of the quality data; and if the user at the terminal device submits a request for inquiring a quality condition of an incoming material to the analyzing module, the retrieving module is prompted by the analyzing module to retrieve quality examined data from the examination database corresponding to a material name of the incoming material, and the tabling module is prompted by the analyzing module to display the retrieved quality examined data in a form of the condition display table on the browser of the terminal device.

14. The system of claim 13, wherein the retrieving module is prompted by the analyzing module to search the examination database if there are newly-established quality examined data relating to an incoming material inferior in quality; and if such quality examined data are available, the analyzing module forms a condition display table by the searched quality examined data of material inferiority, and displays the condition display table through the network communication system to the browser of the terminal device of the manufactory, so as to immediately inform the manufactory of a warning message of material inferiority.

15. The system of claim 13, wherein the network communication system is internet or intranet.
